(19) United States
(12) Patent Application Publication
(10) Pub. No.: US 2026/0245318 A1
(43) Pub. Date: Aug. 20, 2026

(54) DATA TRANSMISSION METHOD, ELECTRONIC DEVICE AND STORAGE MEDIUM

(71) Applicant: Beijing Zitiao Network Technology Co., Ltd., Beijing (CN)

(72) Inventors: Dongzhuang YU, Beijing (CN); Xinyu Cui, Beijing (CN)

(21) Appl. No.: 19/542,630

(22) Filed: Feb. 17, 2026

(30) Foreign Application Priority Data
Feb. 18, 2025 (CN) 202510182577.7

(51) Int. Cl. G06T 19/00; H04L 67/12

(52) U.S. Cl. CPC G06T 19/006; H04L 67/12

(57) ABSTRACT

The present disclosure provides a data transmission method and an electronic device. The method is applicable to a data sending device including an extended reality application, an interface module, and a runtime module, and the method includes: acquiring first extended reality content, which is provided by an extended reality application; and invoking a first interface from an interface module to stream the first extended reality content to a data receiving device through the first interface, wherein the first interface is adapted to different runtime environments in a runtime module.

### CROSS-REFERENCE TO RELATED APPLICATION

This application claims the priority to and benefits of the Chinese Patent Application, No. 202510182577.7, which was filed on February 18, 2025. The aforementioned patent application is hereby incorporated by reference in its entirety.

### TECHNICAL FIELD

One or more embodiments of the present disclosure relate to the field of extended reality technologies, and in particular, to a data transmission method, an apparatus, an electronic device, and a storage medium.

### BACKGROUND

With the continuous development of the network, extended reality (XR) content may be streamed to a user device through the network, so that the user may access and experience high-quality XR content on different devices, thereby realizing a remote XR experience.

In general, while providing a runtime environment (runtime) required for running to the same XR application, different XR device manufacturers may also provide a streaming interface, so that the XR application may transmit the XR content provided by the XR application to the user device based on the streaming interface. The XR application refers to an application program developed based on the XR technology, and may include various types such as virtual reality (VR), augmented reality (AR), and mixed reality (MR).

However, the streaming interfaces provided by different manufacturers are adapted to the runtimes provided by the different manufacturers. When the XR content is transmitted to the user device based on the streaming interface provided by any manufacturer, the XR content cannot be transmitted due to the incompatibility between the streaming interface and the runtimes provided by other manufacturers, resulting in that the user cannot access and experience the same XR content on different devices.

### SUMMARY

One or more embodiments of the present disclosure provide a data transmission method, an apparatus, a device, and a storage medium, which may solve the problem that the user cannot access and experience the same XR content on different devices due to the fact that the XR content cannot be transmitted because the streaming interface is incompatible with the runtimes provided by other manufacturers.

At least an embodiment of the present disclosure provides a data transmission method, which is applicable to a data sending device, where the data sending device includes an extended reality application, an interface module, and a runtime module, and the method includes:

acquiring target extended reality content (e.g., first extended reality content), where the target extended reality content is provided by the extended reality application; and

invoking a target interface (e.g., first interface) from the interface module to stream the target extended reality content to a data receiving device through the target interface, where the target interface is adapted to different runtime environments in the runtime module.

At least an embodiment of the present disclosure further provides a data transmission method, which is applicable to a data receiving device, where the method includes:

receiving target extended reality content transmitted by a data sending device; and

displaying the target extended reality content.

At least an embodiment of the present disclosure further provides a data transmission apparatus, which is configured in a data sending device, where the data sending device includes an extended reality application, an interface module, and a runtime module, and the apparatus includes:

a content acquiring module, configured to acquire target extended reality content, where the target extended reality content is provided by the extended reality application; and

a content transmitting module, configured to invoke a target interface from the interface module to stream the target extended reality content to a data receiving device through the target interface, where the target interface is adapted to different runtime environments in the runtime module.

At least an embodiment of the present disclosure further provides a data transmission apparatus, which is configured in a data receiving device, and the apparatus includes:

a content receiving module, configured to receive target extended reality content transmitted by a data sending device; and

a content displaying module, configured to display the target extended reality content.

At least an embodiment of the present disclosure further provides an electronic device, which includes:

at least one processor; and

a memory communicatively connected to the at least one processor,

wherein the memory is stored with a computer program executable by the at least one processor, and the computer program, when executed by the at least one processor, causes the at least one processor to perform the data transmission method according to the foregoing embodiments of the present disclosure.

At least an embodiment of the present disclosure provides a computer-readable storage medium, which is configured to store a computer program, wherein the computer program causes a computer to perform the data transmission method according to the foregoing embodiments of the present disclosure.

At least an embodiment of the present disclosure provides a computer program product including program instructions, wherein when the program instructions are run on an electronic device, the electronic device is caused to perform the data transmission method according to the foregoing embodiments of present discloses.

### BRIEF DESCRIPTION OF DRAWINGS

In order to more clearly describe the technical solutions in one or more embodiments of the present disclosure, the following will briefly introduce the drawings that need to be used in the description of the embodiments. Obviously, the drawings in the following description are only one or more embodiments of the present disclosure. For those of ordinary skill in the art, other drawings may be obtained based on these drawings without creative efforts.

FIG. 1 is a flowchart of a data transmission method provided by at least an embodiment of the present disclosure;

FIG. 2 is a schematic block diagram of a data sending device provided by at least an embodiment of the present disclosure;

FIG. 3 is a schematic structural diagram of OpenXR provided by at least an embodiment of the present disclosure;

FIG. 4 is a flowchart of another data transmission method provided by at least an embodiment of the present disclosure;

FIG. 5 is a flowchart of yet another data transmission method provided by at least an embodiment of the present disclosure;

FIG. 6 is a schematic block diagram of a data transmission apparatus provided by at least an embodiment of the present disclosure;

FIG. 7 is a schematic block diagram of another data transmission apparatus provided by at least an embodiment of the present disclosure; and

FIG. 8 is a schematic block diagram of an electronic device provided by at least an embodiment of the present disclosure.

### DETAILED DESCRIPTION

The technical solutions in the one or more embodiments of the present disclosure will be described clearly and completely with reference to the drawings in one or more embodiments of the present disclosure. Obviously, the described embodiments are only one or more embodiments of the present disclosure, rather than all the embodiments. All other embodiments obtained by those of ordinary skill in the art based on the embodiments in the present disclosure without paying any creative effort shall fall within the protection scope of the present disclosure.

It should be noted that the terms "first", "second", and the like in the description, claims, and drawings of the present disclosure are used to distinguish similar objects, and are not necessarily used to describe a specific order or sequence. It should be understood that the data termed in such a way may be interchanged under appropriate circumstances, so that one or more embodiments of the present disclosure described herein may be implemented in other orders than those illustrated or described herein. In addition, the terms "include" and "have" and any variations of them are intended to cover non-exclusive inclusions. For example, a process, method, system, product, or server that includes a series of steps or units is not necessarily limited to those expressly listed steps or units, but may include other steps or units not expressly listed or inherent to such a process, method, product, or device.

In one or more embodiments of the present disclosure, words such as "exemplary" or "for example" are used to represent examples, illustrations, or descriptions. Any embodiment or solution described as "exemplary" or "for example" in one or more embodiments of the present disclosure should not be construed as being more preferred or advantageous than other embodiments or solutions. On the contrary, the use of words such as "exemplary" or "for example" is intended to present relevant concepts in a specific manner.

In the description of one or more embodiments of the present disclosure, unless otherwise stated, "a plurality of" refers to two or more, that is, at least two. "At least one" refers to one or more. "Any" refers to any one or any several.

In order to facilitate understanding of one or more embodiments of the present disclosure, before describing each embodiment of the present disclosure, some concepts involved in one or more embodiments of the present disclosure are first appropriately explained and described, as follows:
1) Virtual reality (VR), a technology for creating and experiencing a virtual world, which is a multi-source information (the virtual reality mentioned in the present disclosure includes at least visual perception, and may further include auditory perception, tactile perception, motion perception, and even taste perception, smell perception, etc.), and achieves fusion of a virtual environment, interactive three-dimensional dynamic visual scenes and simulation of entity behavior, enabling the user to immerse in a simulated virtual reality environment, and realizing applications in various virtual environments such as maps, games, videos, education, medical treatment, simulation, collaborative training, sales, assisted manufacturing, maintenance and repair, etc.
2) Virtual reality device (VR device), a terminal for achieving a virtual reality effect, which may usually be provided in a form of glasses, a head-mounted display (HMD), and contact lenses, for achieving visual perception and other forms of perception. Certainly, the form of the virtual reality device is not limited thereto, and may be further miniaturized or enlarged according to actual needs.

Optionally, the virtual reality device described in one or more embodiments of the present disclosure may include, but is not limited to, the following types:

2.1) Personal computer virtual reality (PCVR) device, which uses a PC to perform related calculations and data output of a virtual reality function, and an external PCVR device uses the data output by the PC to achieve the virtual reality effect.

2.2) Mobile virtual reality device, which supports setting a mobile terminal (such as a smart phone) in various ways (such as a head-mounted display provided with a dedicated card slot), and is connected to the mobile terminal in a wired or wireless manner. The mobile terminal performs related calculations of the virtual reality function, and outputs data to the mobile virtual reality device, for example, watching a virtual reality video through an APP of the mobile terminal.

2.3) All-in-one virtual reality device, which has a processor for performing related calculations of the virtual function, and thus has an independent virtual reality input and output function, and does not need to be connected to a PC or a mobile terminal, and has a high degree of freedom in use.

3) Augmented reality (AR): a technology of calculating a camera posture parameter of a camera in a reality world (or referred to as a three-dimensional world, a real world) in real time in a process of image collection by the camera, and adding a virtual element to an image collected by the camera according to the camera posture parameter. The virtual element includes, but is not limited to, an image, a video, and a three-dimensional model. An objective of the AR technology is to overlay a virtual world on the reality world for interaction on a screen.

4) Mixed reality (MR): a simulated setting that integrates computer-created sensory inputs (for example, virtual objects) with sensory inputs from a physical setting or representations thereof. In some MR settings, the computer-created sensory inputs may adapt to changes in the sensory inputs from the physical setting. In addition, some electronic systems for presenting the MR setting may monitor orientation and/or position relative to the physical setting, to enable the virtual objects to interact with real objects (that is, physical elements from the physical setting or representations thereof). For example, the system may monitor motion so that a virtual plant appears to be stationary relative to a physical building.

5) Extended reality (XR) refers to all real and virtual combined environments and frame rate adjustments generated by computer technology and wearable devices, which includes various forms such as virtual reality (VR), augmented reality (AR), and mixed reality (MR).

6) Virtual scene (or referred to as virtual space), a virtual scene displayed (or provided) when an application program runs on an electronic device. The virtual scene may be a simulation environment of the real world, a semi-simulation and semi-fictitious virtual scene, or a pure fictitious virtual scene. The virtual scene may be any of a two-dimensional virtual scene, a 2.5-dimensional virtual scene, or a three-dimensional virtual scene, and the dimension of the virtual scene is not limited in one or more embodiments of the present disclosure. For example, the virtual scene may include a sky, a land, an ocean, etc., and the land may include environmental elements such as a desert and a city.

7) Virtual object (or referred to as virtual item), an object that interacts in the virtual scene, is controlled by a user or a robot program (for example, a robot program based on artificial intelligence), and is capable of being stationary, moving, and performing various behaviors in the virtual scene.

As mentioned above, while providing a runtime environment (runtime) required for running to the same XR application, different XR device manufacturers also provide a streaming interface, so that the XR application may transmit the XR content provided by the XR application to the user device based on the streaming interface, so that the user may access and experience the same XR content on different devices. However, since the streaming interfaces provided by different manufacturers are adapted to the runtimes provided by the different manufacturers, when the XR content is transmitted to the user device based on the streaming interface provided by any manufacturer, the XR content cannot be transmitted due to the incompatibility between the streaming interface and the runtimes provided by other manufacturers, resulting in the problem that the user cannot access and experience the same XR content on different devices.

The present disclosure provides a data transmission method, an apparatus, a device, and a storage medium to solve the problem that the user cannot access and experience the same XR content on different devices due to the fact that the XR content cannot be transmitted because the streaming interface is incompatible with the runtimes provided by other manufacturers, so that the XR content provided by the XR application may be transmitted to the user device no matter which manufacturer provides the runtime, so that the user may access and experience the same XR content on different devices, thereby improving the user experience.

The technical solutions provided by one or more embodiments of the present disclosure are described in detail below through some embodiments. The embodiments described below may be combined with each other, and the same or similar concepts or processes may not be repeated in certain embodiments.

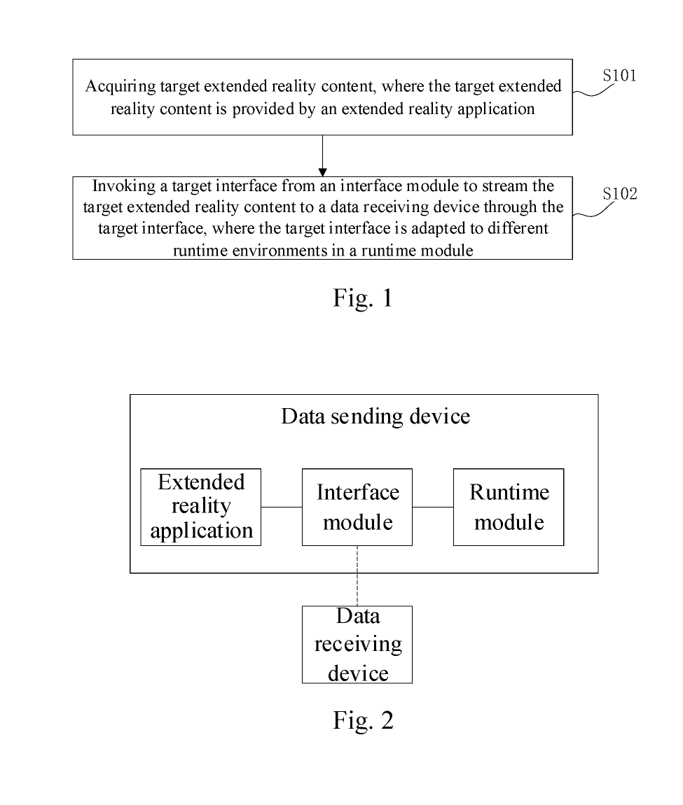

FIG. 1 is a flowchart of a data transmission method provided by an embodiment of the present disclosure. The data transmission method provided by the embodiment of the present disclosure is applicable to a data sending device, and the data sending device may include: an extended reality application, an interface module, and a runtime module. As shown in FIG. 2, an output end of the extended reality application is connected to an input end of the interface module, and an output end of the interface module is connected to the runtime module and a data receiving device, respectively. The runtime module may include a plurality of runtime environments, and each runtime environment may correspond to a different manufacturer. It should be understood that the above runtime environment may be referred to as a runtime.

In addition, in the present disclosure, the number of extended reality applications in the data sending device may be at least one, that is, one or more. Since the implementation principle of transmitting the extended reality content provided by each extended reality application to the data receiving device is the same, for the sake of simplicity of description, one extended reality application will be taken as an example in the following embodiments for detailed description.

As shown in FIG. 1, the method may include the following steps:

S101, acquiring target extended reality content, where the target extended reality content is provided by the extended reality application.

Optionally, when the extended reality application (XR application) is in a running state, the extended reality content (XR content) is continuously generated and updated through a rendering loop, to achieve a continuous XR experience. In the present disclosure, the XR content generated and updated by the XR application may be understood as the above target extended reality content.

In the present disclosure, the above target extended reality content may include, but is not limited to, an audio, an image, a 3D model, and a scene.

In some optional embodiments, the XR application continuously generates and updates the XR content through the rendering loop, which may include the following steps:

In a first step, the XR application invokes an xrWaitFrame interface at a beginning stage of the rendering loop, to wait for a start signal of a next content frame of the data sending device.

In a second step, when receiving the start signal of the next content frame of the data sending device, the XR application may invoke an xrBeginFrame interface to initialize various resources and states required for the XR content to be rendered.

In a third step, the XR application may send a rendering instruction to the data sending device by means of a graphics application programming interface (API), to cause the data sending device to perform a rendering operation according to the various resources and states required for the XR content to be rendered. The rendering instruction may include setting a viewport, a view matrix, and drawing parameter information such as a geometry and a texture in the scene.

In a fourth step, after the rendering is completed, the XR application may invoke an xrEndFrame interface to end a rendering process of the XR content frame to be rendered.

In a fifth step, during invoking the xrEndFrame interface, the data sending device may query a rendering swap chain corresponding to the XR content to be rendered by invoking a function for querying a rendering swap chain image, such as xrEnumerateSwapchainImages.

In a sixth step, the rendered target extended reality content is acquired from the rendering swap chain corresponding to the XR content to be rendered.

In a seventh step, the above first step to sixth step are repeated to perform a rendering operation of a new frame of XR content to be rendered, until the XR application is closed or paused.

It should be understood that the above rendering swap chain is a set of image buffers used to store and display rendering frames in the XR application, and the rendering frames refer to XR content frames.

S102, invoking a target interface from the interface module, to stream the target extended reality content to the data receiving device through the target interface, where the target interface is adapted to different runtime environments in the runtime module.

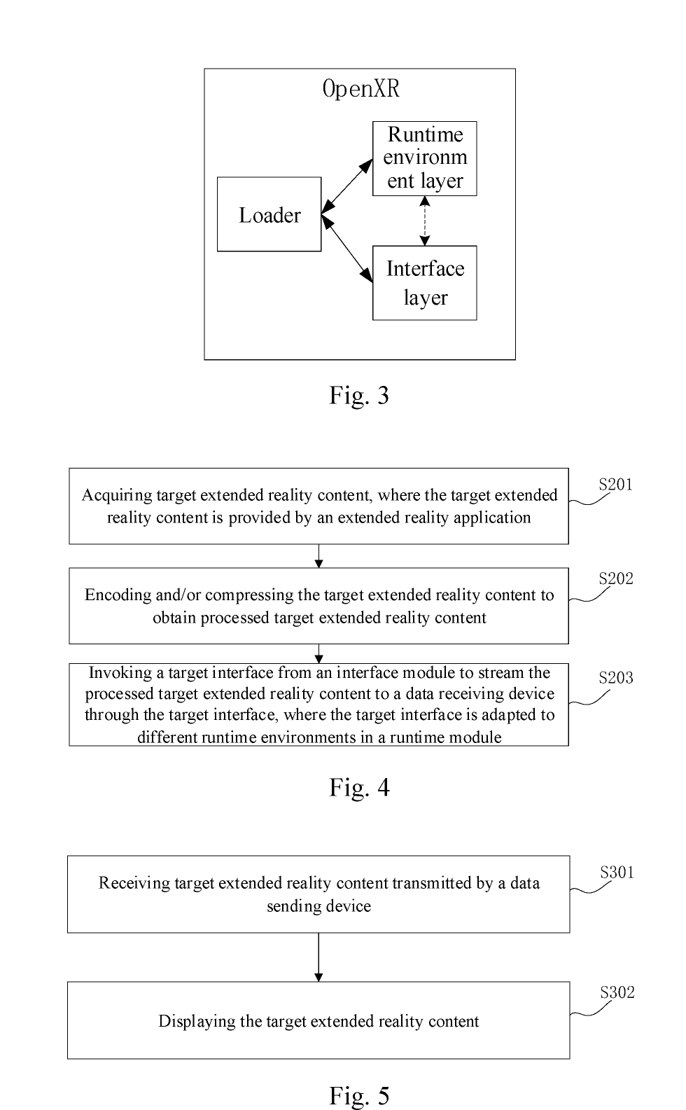

In one or more embodiments of the present disclosure, the interface module may optionally be an API layer in OpenXR. As shown in FIG. 3, the OpenXR is a hierarchical structure, which includes a loader (OpenXR loader), an interface layer (OpenXR API layer), and a runtime environment layer (OpenXR runtime).

In addition, a target interface for transmitting the target extended reality content to the data receiving device is added to the interface module, and the target interface may be compatible with different runtime environments provided by different manufacturers in the runtime module. OpenXR may be referred to as an extended reality development interface.

That is, the target interface is a universal streaming interface that is adapted to different runtime environments in the runtime module and is used to implement XR content streaming.

The XR application in one or more embodiments of the present disclosure may also be an application developed using OpenXR (OpenXR application), which is not specifically limited here.

In some optional embodiments, the target interface in the above interface module may be obtained through the following steps:

In step 1, generating the target interface according to an OpenXR specification and data transmission interfaces corresponding to the different runtime environments in the runtime module.

In step 2, adding the target interface to the interface module.

The data transmission interfaces corresponding to the above different runtime environments may be understood as streaming interfaces corresponding to the different runtime environments.

As shown in FIG. 2, the above interface module is located between the XR application and the runtime module, and is used to connect the XR application and the runtime module. When the above target interface is generated, the streaming interface corresponding to each runtime environment in the runtime module for realizing remote transmission of XR content may be intercepted. After that, by analyzing a same part and a difference part of the streaming interfaces corresponding to each runtime environment, a technician designs a universal streaming interface related to the streaming service according to the OpenXR specification and the same part and the difference part of the streaming interfaces corresponding to each runtime environment, and rewrites implementation source code of the universal streaming interface to obtain the target interface, so that the target interface may be compatible with the runtime environments of different manufacturers, and at the same time, the requirement for universal data transmission is met.

In one or more embodiments of the present disclosure, when the technician rewrites the implementation source code of the universal streaming interface, it is necessary to write code for interacting with an OpenXR API, code for processing data transmission, code for communicating with the runtime environments of different manufacturers, and the like in the source code.

After that, the generated target interface may be added to the interface module, so that the data sending device may acquire the universal streaming interface from the interface module to perform a remote transmission operation of XR content.

It should be noted that, in addition to the target interface, the above interface module may further include a basic function interface that supports the normal operation of the XR application under the OpenXR specification. These basic function interfaces may be universal basic function interfaces provided by different runtime environments, such as an initialization interface, a configuration interface, an input processing interface, and a rendering interface, which are not specifically limited here.

It should be understood that the above basic function interfaces refer to necessary basic functions that support the normal operation of the XR application.

After the target extended reality content to be transmitted is acquired, the target interface for realizing XR content streaming may be acquired from the interface module in the present disclosure. Then, the target interface is invoked to stream the target extended reality content to the data receiving device through the target interface, so that the data receiving device may perform a content displaying operation according to the received target extended reality content.

In some optional embodiments, in the present disclosure, the target extended reality content is transmitted to the data receiving device by wire, such as a USB data line, etc. by invoking the target interface; or, the target extended reality content may also be transmitted to the data receiving device by wireless, such as WIFI or Bluetooth, etc. by invoking the target interface, which is not specifically limited in the present disclosure.

According to the technical solution disclosed in one or more embodiments of the present disclosure, the target extended reality content provided by the extended reality application is acquired, and the target interface is invoked from the interface module, to stream the target extended reality content to the data receiving device through the target interface, where the target interface is adapted to different runtime environments in the runtime module. In this way, by adding a universal streaming interface supporting the streaming function to the interface module and adapting to the runtime environments provided by different manufacturers through the universal streaming interface, the XR content provided by the XR application may be transmitted to the user device, so that the user may access and experience the same XR content on different devices, thereby improving the user experience.

Based on the foregoing embodiments, it is considered that the data receiving device may be different types of user devices such as an XR device and a tablet computer. Then, various sensors, such as an inertial sensor, a camera, and other sensors, may be provided on the data receiving device. In addition, the data receiving device may further be equipped with an interaction accessory having a key, such as a handle, a remote controller, or a keyboard, so that the user may perform a corresponding operation, such as switching a viewing angle, through key input.

Then, one or more embodiments of the present disclosure may further include: receiving interaction data transmitted by the data receiving device; and transmitting corresponding target extended reality content to the data receiving device according to the interaction data.

In some optional embodiments, when the user uses the data receiving device, the head of the user may move, the hand of the user may move, and/or the user may input an interaction operation through the key on the interaction accessory. Then, in one or more embodiments of the present disclosure, the head position and the head posture of the user may be tracked in real time by the inertial sensor in the data receiving device, the hand position and the hand posture of the user may be tracked in real time by the camera in the data receiving device, and/or the trigger operation of the key in the interaction accessory may be received to obtain key operation data. Furthermore, the data receiving device may transmit the acquired interaction data to the data sending device, and the data sending device may adjust the target extended reality content according to the received interaction data, so that the target extended reality content corresponds to the head posture of the user, the hand posture of the user, and/or the key operation data, thereby ensuring that the XR content seen by the user through the user device is synchronized with the head movement, the hand movement, and/or the key operation data, and thus providing a more natural, smooth, and immersive experience for the user.

That is, when the user turns the head or changes the head position, the XR content displayed by the data receiving device to the user may be adjusted according to the real-time posture of the head of the user; when the user moves the hand or changes the hand posture, the XR content displayed by the data receiving device to the user may be adjusted according to the real-time posture of the hand of the user; and/or when the user triggers any key on the interaction accessory, the XR content displayed by the data receiving device to the user may be adjusted according to the key operation data.

The data transmission method provided by one or more embodiments of the present disclosure is further explained below with reference to FIG. 4. As shown in FIG. 4, the method may include the following steps:

S201, acquiring target extended reality content, where the target extended reality content is provided by an extended reality application.

S202, encoding and/or compressing the target extended reality content to obtain processed target extended reality content.

S203, invoking a target interface from an interface module to stream the processed target extended reality content to a data receiving device through the target interface, where the target interface is adapted to different runtime environments in a runtime module.

Considering that the device types or the operating systems between the data sending device and the data receiving device may be different, for example, when the operating system of the data sending device is an Android system, and the operating system of the data receiving device is Windows, etc., before transmitting the target extended reality content to the data receiving device, the data sending device in one or more embodiments of the present disclosure optionally first encodes the target extended reality content according to a pre-agreed encoding technology, and then sends the encoded target extended reality content to the data receiving device, so that the data receiving device may correctly parse the XR content sent by the data sending device and perform a displaying operation according to a pre-agreed decoding technology.

In some optional embodiments, after acquiring the target extended reality content, the data sending device may encode the target extended reality content according to a pre-agreed encoding technology to obtain encoded target extended reality content. Furthermore, the encoded target extended reality content is streamed to the data receiving device through the target interface.

In the present disclosure, the above encoding technology may be determined according to a type of the XR content. For example, when the XR content is an image, the encoding technology may optionally be a vector quantization encoding technology or a transform encoding technology. When the XR content is video data, the encoding technology may optionally be MPEG-1, MPEG-2, MPEG-4, H.264, H.265, or MJPEG, etc., and the encoding technology is not limited here.

In some optional embodiments, since the data is compressed, the data volume may be reduced and the transmission speed may be improved. After encoding the target extended reality content, the data sending device may optionally further compress the encoded target extended reality content. Then, the compressed target extended reality content is streamed to the data receiving device through the target interface, so that the data transmission volume may be further reduced and the data transmission efficiency may be improved.

Considering that the device types or the operating systems between the data sending device and the data receiving device may also be the same, before streaming the target extended reality content to the data receiving device through the target interface, the data sending device may optionally further compress the target extended reality content, and then stream the target extended reality content to the data receiving device by invoking the target interface.

It should be understood that the above encoding and/or compressing of the target extended reality content may be encoding processing of the target extended reality content; or, may be compressing processing of the target extended reality content; or, may also be encoding and compressing processing of the target extended reality content, which is not specifically limited here.

According to the technical solution disclosed in one or more embodiments of the present disclosure, the target extended reality content provided by the extended reality application is acquired, and the target interface is invoked from the interface module, to stream the target extended reality content to the data receiving device through the target interface, where the target interface is adapted to different runtime environments in the runtime module. In this way, by adding a universal streaming interface supporting the streaming function to the interface module and adapting to the runtime environments provided by different manufacturers through the universal streaming interface, the XR content provided by the XR application may be transmitted to the user device, so that the user may access and experience the same XR content on different devices, thereby improving the user experience. In addition, by encoding and/or compressing the target extended reality content, the XR content may be transmitted between different device types or operating systems, and the data transmission volume may be reduced and the data transmission efficiency may be improved.

The data transmission method applicable to the data receiving device is specifically described below with reference to FIG. 5. As shown in FIG. 5, the method may include the following steps:

S301, receiving target extended reality content transmitted by a data sending device.

S302, displaying the target extended reality content.

Optionally, after receiving the target extended reality content transmitted by the data sending device through the target interface, the data receiving device may display the target extended reality content to realize sharing of the XR content between different devices.

It is considered that the data receiving device may be different types of user devices such as an XR device and a tablet computer. Then, various sensors, such as an inertial sensor, a camera, and other sensors, may be provided on the data receiving device. In addition, the data receiving device may further be equipped with an interaction accessory having a key, such as a handle, a remote controller, or a keyboard, so that the user may perform a corresponding operation, such as switching a viewing angle, through key input.

Then, one or more embodiments of the present disclosure may optionally include: acquiring interaction data input by the user; and transmitting the interaction data to the data sending device, so that the data sending device transmits corresponding target extended reality content according to the interaction data.

In some optional embodiments, when the user uses the data receiving device, the head of the user may move, the hand of the user may move, and/or the user may input an interaction operation through the key on the interaction accessory. Then, in the present disclosure, the head position and the head posture of the user may be tracked in real time by the inertial sensor in the data receiving device, the hand position and the hand posture of the user may be tracked in real time by the camera in the data receiving device, and/or the trigger operation of the key in the interaction accessory may be received to obtain key operation data. Furthermore, the data receiving device may transmit the acquired interaction data to the data sending device, and the data sending device may adjust the target extended reality content according to the received interaction data, so that the target extended reality content corresponds to the head posture of the user, the hand posture of the user, and/or the key operation data, thereby ensuring that the XR content seen by the user through the user device is synchronized with the head movement, the hand movement, and/or the key operation data, and thus providing a more natural, smooth, and immersive experience for the user.

That is, when the user turns the head or changes the head position, the XR content displayed by the data receiving device to the user may be adjusted according to the real-time posture of the head of the user; when the user moves the hand or changes the hand posture, the XR content displayed by the data receiving device to the user may be adjusted according to the real-time posture of the hand of the user; and/or when the user triggers any key on the interaction accessory, the XR content displayed by the data receiving device to the user may be adjusted according to the key operation data.

According to the technical solution disclosed in one or more embodiments of the present disclosure, the data sending device acquires the target extended reality content provided by the extended reality application, and invokes the target interface from the interface module to stream the target extended reality content to the data receiving device through the target interface, so that the data receiving device displays the received target extended reality content, where the target interface is adapted to different runtime environments in the runtime module. In this way, by adding a universal streaming interface supporting the streaming function to the interface module and adapting to the runtime environments provided by different manufacturers through the universal streaming interface, the XR content provided by the XR application may be transmitted to the user device, so that the user may access and experience the same XR content on different devices, thereby improving the user experience.

Based on the above embodiments, it is considered that the target extended reality content transmitted by the data sending device may be encoded and/or compressed. That is, the target extended reality content is the target extended reality content processed by encoding and/or compressing, so when receiving the target extended reality content transmitted by the data sending device, the present disclosure needs to perform decoding and/or decompressing processing, and then perform the displaying operation.

In some optional embodiments, after receiving the target extended reality content transmitted by the data sending device, where the target extended reality content is the target extended reality content processed by encoding and/or compressing, the data receiving device in one or more embodiments of the present disclosure may optionally include: decoding and/or decompressing the processed target extended reality content; and displaying the target extended reality content processed by decoding and/or decompressing.

Optionally, in one or more embodiments of the present disclosure, the processed target extended reality content may be decoded and/or decompressed according to a pre-agreed decoding technology and/or decompressing technology to obtain the target extended reality content, and the data receiving device displays the target extended reality content to the user through a screen. In this way, by encoding and/or compressing the target extended reality content by the data sending device, the XR content may be transmitted between devices with different operating systems, and the data transmission volume may be reduced and the data transmission efficiency may be improved.

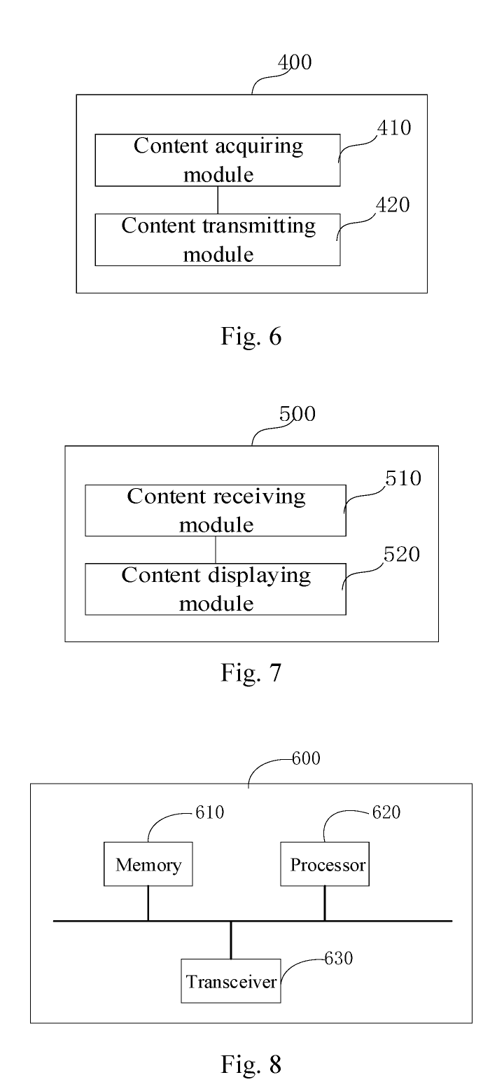

A data transmission apparatus proposed by one or more embodiments of the present disclosure is described below with reference to FIG. 6. In the present disclosure, the data transmission apparatus is configured in a data sending device, and the data sending device includes an extended reality application, an interface module, and a runtime module. As shown in FIG. 6, the data transmission apparatus 400 includes a content acquiring module 410 and a content transmitting module 420.

The content acquiring module 410 is configured to acquire target extended reality content, where the target extended reality content is provided by the extended reality application; and

the content transmitting module 420 is configured to invoke a target interface from the interface module to stream the target extended reality content to a data receiving device through the target interface, where the target interface is adapted to different runtime environments in the runtime module.

In an optional implementation of one or more embodiments of the present disclosure, the data transmission apparatus 400 further includes:

an interface generating module, configured to generate the target interface according to an extended reality development interface specification and data transmission interfaces corresponding to the different runtime environments in the runtime module; and

an interface adding module, configured to add the target interface to the interface module.

In an optional implementation of one or more embodiments of the present disclosure, the data transmission apparatus 400 further includes:

a content processing module, configured to encode and/or compress the target extended reality content to obtain processed target extended reality content; and

accordingly, the content transmitting module 420 is further configured to:

stream the processed target extended reality content to the data receiving device through the target interface.

In an optional implementation of one or more embodiments of the present disclosure, the extended reality application includes an end frame interface, and the content acquiring module 410 is further configured to:

search for a rendering swap chain corresponding to the target extended reality content in the end frame interface; and

acquire the target extended reality content from the rendering swap chain.

In an optional implementation of one or more embodiments of the present disclosure, the data transmission apparatus 400 further includes:

a data receiving module, configured to receive interaction data transmitted by the data receiving device; and

the content transmitting module 420, further configured to transmit corresponding target extended reality content to the data receiving device according to the interaction data.

It should be understood that the apparatus embodiment may correspond to the foregoing method embodiment of the first aspect. For similar descriptions, reference may be made to the method embodiment. To avoid repetitions, details are not described herein again. Specifically, the apparatus 400 shown in FIG. 6 may perform the method embodiment corresponding to FIG. 1, and the foregoing and other operations and/or functions of the modules in the apparatus 400 are respectively intended to implement corresponding procedures of the methods in FIG. 1, which are not described herein again for the sake of brevity.

The apparatus 400 in one or more embodiments of the present disclosure is described above with reference to the drawings from the perspective of a functional module. It should be understood that the functional module may be implemented in the form of hardware, or may be implemented by instructions in the form of software, or may be implemented by a combination of hardware and a software module. Specifically, the steps in the method embodiment of the first aspect in one or more embodiments of the present disclosure may be completed by a hardware integrated logic circuit in a processor and/or the instructions in the form of the software. The steps of the method of the first aspect disclosed in one or more embodiments of the present disclosure may be directly embodied to be completed by a hardware decoding processor or by a combination of hardware in the decoding processor and a software module. Optionally, the software module may be located in a mature storage medium in the art, such as a random access memory, a flash memory, a read-only memory, a programmable read-only memory, an electrically erasable programmable memory, or a register. The storage medium is located in a memory. The processor reads information in the memory, and completes the steps in the foregoing method embodiment of the first aspect in combination with the hardware of the processor.

Another data transmission apparatus proposed by one or more embodiments of the present disclosure is described below with reference to FIG. 7. In the present disclosure, the data transmission apparatus is configured in a data receiving device. As shown in FIG. 7, the data transmission apparatus 500 includes a content receiving module 510 and a content displaying module 520.

The content receiving module 510 is configured to receive target extended reality content transmitted by a data sending device; and

the content displaying module 520 is configured to display the target extended reality content.

In an optional implementation of one or more embodiments of the present disclosure, in response to that the target extended reality content is target extended reality content processed by encoding and/or compressing, the data transmission apparatus 500 further includes:

a recovery processing module, configured to decode and/or decompress processed target extended reality content; and

accordingly, the content displaying module 520, further configured to:

display the target extended reality content processed by decoding and/or decompressing.

In an optional implementation of one or more embodiments of the present disclosure, the data transmission apparatus 500 further includes:

a data acquiring module, configured to acquire interaction data input by a user; and

a data transmitting module, configured to transmit the interaction data to the data sending device, so that the data sending device transmits corresponding target extended reality content according to the interaction data.

It should be understood that the apparatus embodiment may correspond to the foregoing method embodiment of the second aspect. For similar descriptions, reference may be made to the method embodiment. To avoid repetitions, details are not described herein again. Specifically, the apparatus 500 shown in FIG. 7 may perform the method embodiment corresponding to FIG. 5, and the foregoing and other operations and/or functions of the modules in the apparatus 500 are respectively intended to implement corresponding procedures of the methods in FIG. 5, which are not described herein again for the sake of brevity.

The apparatus 500 in one or more embodiments of the present disclosure is described above with reference to the drawings from the perspective of a functional module. It should be understood that the functional module may be implemented in the form of hardware, or may be implemented by instructions in the form of software, or may be implemented by a combination of hardware and a software module. Specifically, the steps in the method embodiment of the second aspect in one or more embodiments of the present disclosure may be completed by a hardware integrated logic circuit in a processor and/or the instructions in the form of the software. The steps of the method of the second aspect disclosed in one or more embodiments of the present disclosure may be directly embodied to be completed by a hardware decoding processor or by a combination of hardware in the decoding processor and a software module. Optionally, the software module may be located in a mature storage medium in the art, such as a random access memory, a flash memory, a read-only memory, a programmable read-only memory, an electrically erasable programmable memory, or a register. The storage medium is located in a memory. The processor reads information in the memory, and completes the steps in the foregoing method embodiment of the second aspect in combination with the hardware of the processor.

FIG. 8 is a schematic block diagram of an electronic device provided by an embodiment of the present disclosure. As shown in FIG. 8, the electronic device 600 may include: a memory 610 and a processor 620, where the memory 610 is configured to store a computer program, and transmit the program code to the processor 620. In other words, the processor 620 may invoke and run the computer program from the memory 610 to implement the data transmission method according to the foregoing first aspect or the data transmission method according to the foregoing second aspect in one or more embodiments of the present disclosure.

For example, the processor 620 may be configured to perform the data transmission method according to the foregoing first aspect or the data transmission method according to the foregoing second aspect according to instructions in the computer program.

In some optional embodiments, the data transmission method according to the foregoing first aspect is applicable to a data sending device, where the data sending device includes an extended reality application, an interface module, and a runtime module, and the method includes:

acquiring target extended reality content, where the target extended reality content is provided by the extended reality application; and

invoking a target interface from the interface module to stream the target extended reality content to a data receiving device through the target interface, where the target interface is adapted to different runtime environments in the runtime module.

In some optional embodiments, the method further includes:

generating the target interface according to an extended reality development interface specification and data transmission interfaces corresponding to the different runtime environments in the runtime module; and

adding the target interface to the interface module.

In some optional embodiments, the method further includes:

encoding and/or compressing the target extended reality content to obtain processed target extended reality content; and

accordingly, streaming the target extended reality content to the data receiving device through the target interface includes:

streaming the processed target extended reality content to the data receiving device through the target interface.

In some optional embodiments, the extended reality application includes an end frame interface, and the acquiring target extended reality content includes:

searching for a rendering swap chain corresponding to the target extended reality content in the end frame interface; and

acquiring the target extended reality content from the rendering swap chain.

In some optional embodiments, the method further includes:

receiving interaction data transmitted by the data receiving device; and

transmitting corresponding target extended reality content to the data receiving device according to the interaction data.

In some optional embodiments, the data transmission method according to the foregoing second aspect is applicable to a data receiving device, and the method includes:

receiving target extended reality content transmitted by the data sending device; and

displaying the target extended reality content.

In some optional embodiments, in response to that the target extended reality content is target extended reality content processed by encoding and/or compressing, the method further includes:

decoding and/or decompressing processed target extended reality content; and

accordingly, the displaying the target extended reality content includes:

displaying the target extended reality content processed by decoding and/or decompressing.

In some optional embodiments, the method further includes:

acquiring interaction data input by a user; and

transmitting the interaction data to the data sending device, so that the data sending device transmits corresponding target extended reality content according to the interaction data.

In some embodiments of the present disclosure, the processor 620 may include, but is not limited to:

a general-purpose processor, a digital signal processor (DSP), an application specific integrated circuit (ASIC), a field programmable gate array (FPGA) or other programmable logic devices, a discrete gate or transistor logic device, a discrete hardware component, etc.

In some embodiments of the present disclosure, the memory 610 includes, but is not limited to:

a volatile memory and/or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of exemplary but non-restrictive description, many forms of RAMs may be used, such as a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synch link dynamic random access memory (SLDRAM), and a direct rambus random access memory (DR RAM).

In some embodiments of the present disclosure, the computer program may be divided into one or more modules, and the one or more modules are stored in the memory 610 and executed by the processor 620 to complete the data transmission method provided by the present disclosure. The one or more modules may be a series of computer program instruction segments capable of completing specific functions, and the instruction segments are used to describe an execution process of the computer program in the electronic device.

As shown in FIG. 8, the electronic device 600 may further include:

a transceiver 630, which may be connected to the processor 620 or the memory 610.

The processor 620 may control the transceiver 630 to communicate with other devices, specifically to send information or data to other devices or to receive information or data sent by other devices. The transceiver 630 may include a transmitter and a receiver. The transceiver 630 may further include an antenna, and the number of antennas may be one or more.

It should be understood that the components of the electronic device are connected to each other through a bus system. In addition to a data bus, the bus system further includes a power bus, a control bus, and a status signal bus.

The present disclosure further provides a computer storage medium having a computer program stored thereon, where the computer program, when executed by a computer, causes the computer to perform the data transmission method according to the foregoing first aspect or the data transmission method according to the foregoing second aspect.

In some optional embodiments, the data transmission method according to the foregoing first aspect is applicable to a data sending device, where the data sending device includes an extended reality application, an interface module, and a runtime module, and the method includes:

acquiring target extended reality content, where the target extended reality content is provided by the extended reality application; and

invoking a target interface from the interface module to stream the target extended reality content to a data receiving device through the target interface, where the target interface is adapted to different runtime environments in the runtime module.

In some optional embodiments, the method further includes:

generating the target interface according to an extended reality development interface specification and data transmission interfaces corresponding to the different runtime environments in the runtime module; and

adding the target interface to the interface module.

In some optional embodiments, the method further includes:

encoding and/or compressing the target extended reality content to obtain processed target extended reality content; and

accordingly, the streaming the target extended reality content to a data receiving device through the target interface includes:

streaming the processed target extended reality content to the data receiving device through the target interface.

In some optional embodiments, the extended reality application includes an end frame interface, and the acquiring target extended reality content includes:

searching for a rendering swap chain corresponding to the target extended reality content in the end frame interface; and

acquiring the target extended reality content from the rendering swap chain.

In some optional embodiments, the method further includes:

receiving interaction data transmitted by the data receiving device; and

transmitting corresponding target extended reality content to the data receiving device according to the interaction data.

In some optional embodiments, the data transmission method according to the foregoing second aspect is applicable to a data receiving device, and the method includes:

receiving target extended reality content transmitted by the data sending device; and

displaying the target extended reality content.

In some optional embodiments, in response to that the target extended reality content is target extended reality content processed by encoding and/or compressing, the method further includes:

decoding and/or decompressing processed target extended reality content; and

accordingly, the displaying the target extended reality content includes:

displaying the target extended reality content processed by decoding and/or decompressing.

In some optional embodiments, the method further includes:

acquiring interaction data input by a user; and

transmitting the interaction data to the data sending device, so that the data sending device transmits corresponding target extended reality content according to the interaction data.

The present disclosure further provides a computer program product including program instructions, where when the program instructions are run on an electronic device, the electronic device is caused to perform the data transmission method according to the foregoing first aspect or the data transmission method according to the foregoing second aspect.

In some optional embodiments, the data transmission method according to the foregoing first aspect is applicable to a data sending device, where the data sending device includes an extended reality application, an interface module, and a runtime module, and the method includes:

acquiring target extended reality content, where the target extended reality content is provided by the extended reality application; and

invoking a target interface from the interface module to stream the target extended reality content to a data receiving device through the target interface, where the target interface is adapted to different runtime environments in the runtime module.

In some optional embodiments, the method further includes:

generating the target interface according to an extended reality development interface specification and data transmission interfaces corresponding to the different runtime environments in the runtime module; and

adding the target interface to the interface module.

In some optional embodiments, the method further includes:

encoding and/or compressing the target extended reality content to obtain processed target extended reality content; and

accordingly, the streaming the target extended reality content to a data receiving device through the target interface includes:

streaming the processed target extended reality content to the data receiving device through the target interface.

In some optional embodiments, the extended reality application includes an end frame interface, and the acquiring target extended reality content includes:

searching for a rendering swap chain corresponding to the target extended reality content in the end frame interface; and

acquiring the target extended reality content from the rendering swap chain.

In some optional embodiments, the method further includes:

receiving interaction data transmitted by the data receiving device; and

transmitting corresponding target extended reality content to the data receiving device according to the interaction data.

In some optional embodiments, the data transmission method according to the foregoing second aspect is applicable to a data receiving device, and the method includes:

receiving target extended reality content transmitted by the data sending device; and

displaying the target extended reality content.

In some optional embodiments, in response to that the target extended reality content is target extended reality content processed by encoding and/or compressing, the method further includes:

decoding and/or decompressing processed target extended reality content; and

accordingly, the displaying the target extended reality content includes:

displaying the target extended reality content processed by decoding and/or decompressing.

In some optional embodiments, the method further includes:

acquiring interaction data input by a user; and

transmitting the interaction data to the data sending device, so that the data sending device transmits corresponding target extended reality content according to the interaction data.

When software is used to implement one or more embodiments, one or more embodiments may be implemented completely or partially in a form of a computer program product. The computer program product includes one or more computer instructions. When the computer program instructions are loaded and executed on a computer, the procedures or functions according to one or more embodiments of the present disclosure are all or partially generated. The computer may be a general-purpose computer, a dedicated computer, a computer network, or another programmable apparatus. The computer instructions may be stored in a computer-readable storage medium or may be transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

It may be realized by those of ordinary skill in the art that the modules and algorithm steps of various examples described in conjunction with one or more embodiments disclosed herein may be implemented in electronic hardware or a combination of computer software and electronic hardware. Whether these functions are performed in hardware or software depends on the specific application and design constraints of the technical solution. A person skilled in the art may implement the described functions by using different methods for each particular application, but such implementation should not be considered as going beyond the scope of the present disclosure.

It should be understood that the systems, apparatuses, and methods disclosed in some embodiments of the present disclosure may be implemented in other manners. For example, the apparatus embodiments described above are merely examples. For example, the module division is merely logical function division and may be other division during actual implementation. For example, a plurality of modules or components may be combined or integrated into another system, or some features may be ignored or not performed. In addition, other items shown or discussed as coupled, directly coupled, or communicating with each other may be indirectly coupled or communicating through some interface, apparatus, or module whether electrically, mechanically, or otherwise.

The modules described as separate parts may or may not be physically separate, and parts displayed as modules may or may not be physical modules, and may be located at one position, or may be distributed on a plurality of network units. Some or all of the modules may be selected according to actual needs to achieve the objectives of the solutions of one or more embodiments. For example, functional modules in one or more embodiments of the present disclosure may be integrated into one processing module, each of the modules may exist alone physically, or two or more modules may be integrated into one module.

In one or more embodiments of the present disclosure, the term "module" or "unit" refers to a computer program or a part of a computer program with a predetermined function, and works with other related parts to achieve a predetermined objective, and may be implemented in whole or in part by using software, hardware (such as a processing circuit or a memory), or a combination thereof. Similarly, one processor (or a plurality of processors or memories) may be used to implement one or more modules or units. In addition, each module or unit may be a part of an overall module or unit that includes functions of the module or unit.

The foregoing descriptions are merely specific implementations of the present disclosure, but are not intended to limit the scope of protection of the present disclosure. Any variation or replacement readily figured out by a person skilled in the art within the technical scope disclosed in the present disclosure shall fall within the scope of protection of the present disclosure. Therefore, the scope of protection of the present disclosure shall be subject to the scope of protection of the claims.

1. A data transmission method, which is applicable to a data sending device comprising an extended reality application, an interface module, and a runtime module, comprising:
acquiring first extended reality content, which is provided by the extended reality application; and
invoking a first interface from the interface module, to stream the first extended reality content to a data receiving device through the first interface, wherein the first interface is adapted to different runtime environments in the runtime module.

2. The method of claim 1, further comprising:
generating the first interface according to an extended reality development interface specification and data transmission interfaces corresponding to the different runtime environments in the runtime module; and
adding the first interface to the interface module.

3. The method of claim 2, further comprising:
receiving interaction data transmitted by the data receiving device; and
transmitting corresponding first extended reality content to the data receiving device according to the interaction data.

4. The method of claim 1, further comprising at least one selected from the group of: encoding the first extended reality content to obtain processed first extended reality content, and compressing the first extended reality content to obtain processed first extended reality content,
wherein the streaming the first extended reality content to a data receiving device through the first interface comprises:
streaming the processed first extended reality content to the data receiving device through the first interface.

5. The method of claim 4, further comprising:
receiving interaction data transmitted by the data receiving device; and
transmitting corresponding first extended reality content to the data receiving device according to the interaction data.

6. The method of claim 1, wherein the extended reality application comprises an end frame interface, and the acquiring first extended reality content comprises:
searching for a rendering swap chain corresponding to the first extended reality content in the end frame interface; and
acquiring the first extended reality content from the rendering swap chain.

7. The method of claim 6, further comprising:
receiving interaction data transmitted by the data receiving device; and
transmitting corresponding first extended reality content to the data receiving device according to the interaction data.

8. The method of claim 1, further comprising:
receiving interaction data transmitted by the data receiving device; and
transmitting corresponding first extended reality content to the data receiving device according to the interaction data.

9. An electronic device, comprising:
at least one processor; and
a memory communicatively connected to the at least one processor,
wherein the memory is stored with a computer program executable by the at least one processor, and the computer program, when executed by the at least one processor, causes the at least one processor to perform a data transmission method, which is applicable to a data sending device comprising an extended reality application, an interface module, and a runtime module, and comprises:
acquiring first extended reality content, which is provided by the extended reality application; and
invoking a first interface from the interface module, to stream the first extended reality content to a data receiving device through the first interface, wherein the first interface is adapted to different runtime environments in the runtime module.

10. The electronic device of claim 9, wherein the at least one processor is caused to further perform:
generating the first interface according to an extended reality development interface specification and data transmission interfaces corresponding to the different runtime environments in the runtime module; and
adding the first interface to the interface module.

11. The electronic device of claim 10, wherein the at least one processor is caused to further perform:
receiving interaction data transmitted by the data receiving device; and
transmitting corresponding first extended reality content to the data receiving device according to the interaction data.

12. The electronic device of claim 9, wherein the at least one processor is caused to further perform at least one selected from the group of: encoding the first extended reality content to obtain processed first extended reality content; and compressing the first extended reality content to obtain processed first extended reality content; and
wherein the streaming the first extended reality content to a data receiving device through the first interface comprises:
streaming the processed first extended reality content to the data receiving device through the first interface.

13. The electronic device of claim 9, wherein the extended reality application comprises an end frame interface, and the acquiring first extended reality content comprises:
searching for a rendering swap chain corresponding to the first extended reality content in the end frame interface; and
acquiring the first extended reality content from the rendering swap chain.

14. The electronic device of claim 9, wherein the at least one processor is caused to further perform:
receiving interaction data transmitted by the data receiving device; and
transmitting corresponding first extended reality content to the data receiving device according to the interaction data.

15. A non-transitory computer-readable storage medium, which is configured to store a computer program, wherein the computer program, when executed by at least a processor, causes the processor to perform a data transmission method, which is applicable to a data sending device comprising an extended reality application, an interface module, and a runtime module, and comprises:
acquiring first extended reality content, which is provided by the extended reality application; and
invoking a first interface from the interface module, to stream the first extended reality content to a data receiving device through the first interface, wherein the first interface is adapted to different runtime environments in the runtime module.

16. The storage medium of claim 15, wherein the processor is caused to further perform:
generating the first interface according to an extended reality development interface specification and data transmission interfaces corresponding to the different runtime environments in the runtime module; and
adding the first interface to the interface module.

17. The storage medium of claim 16, wherein the processor is caused to further perform:
receiving interaction data transmitted by the data receiving device; and
transmitting corresponding first extended reality content to the data receiving device according to the interaction data.

18. The storage medium of claim 15, wherein the at least one processor is caused to further perform at least one selected from the group of: encoding the first extended reality content to obtain processed first extended reality content; and compressing the first extended reality content to obtain processed first extended reality content; and
wherein the streaming the first extended reality content to a data receiving device through the first interface comprises:
streaming the processed first extended reality content to the data receiving device through the first interface.

19. The storage medium of claim 15, wherein the extended reality application comprises an end frame interface, and the acquiring first extended reality content comprises:
searching for a rendering swap chain corresponding to the first extended reality content in the end frame interface; and
acquiring the first extended reality content from the rendering swap chain.

20. The storage medium of claim 15, wherein the at least one processor is caused to further perform:
receiving interaction data transmitted by the data receiving device; and
transmitting corresponding first extended reality content to the data receiving device according to the interaction data.
